(19) United States
(12) Patent Application Publication
(10) Pub. No.: US 2014/0119421 A1
(43) Pub. Date: May 1, 2014

(54) Testing Radio-Frequency Performance of Wireless Communications Circuitry Using Fast Fourier Transforms

(71) Applicant: APPLE INC., Cupertino, CA (US)

(72) Inventor: Wassim El-Hassan, Cupertino, CA (US)

(73) Assignee: Apple Inc., Cupertino, CA (US)

(21) Appl. No.: 13/663,336

(22) Filed: Oct. 29, 2012

(51) Int. Cl. H04B 17/00

(52) U.S. Cl. 375/227; 375/224

(57) ABSTRACT

A test system for testing wireless circuitry in an electronic device is provided. The test system may include a test host and a tester. The tester may provide radio-frequency test signals to a device under test (DUT). The DUT may include radio-frequency decoding circuitry that processes the test signals using a communications protocol and digital demodulator circuitry that processes the test signals without using the communications protocol. The digital demodulator circuitry may include transformation circuitry that performs fast Fourier transforms on the test signals to create frequency-domain performance data. The test host may compute a noise floor and signal-to-noise ratio based on the frequency-domain performance data. The test host may compare the computed noise floor and signal-to-noise ratio to predetermined thresholds to characterize the radio-frequency performance of the wireless circuitry.

### BACKGROUND

This invention relates generally to electronic devices having wireless communications circuitry, and more particularly, to testing wireless communications circuitry in electronic devices.

Electronic devices such as portable computers and cellular telephones are often provided with wireless communications circuitry. The wireless communications circuitry is operable to receive radio-frequency signals. The wireless communications circuitry includes radio-frequency front-end circuitry for amplifying the received radio-frequency signals, bit-based digital signal processing circuitry for processing the received signals, and protocol-based physical layer processing circuitry for performing protocol-based operations on the received signals.

Electrical components in the radio-frequency front-end circuitry typically exhibit non-linearity and noise that can potentially degrade the received signals. The receive performance of the radio-frequency front-end circuitry is typically characterized by a metric such as bit error rate. The wireless communications circuitry may fail to satisfy design criteria when there are too many errors in the received signals (i.e., if the bit error rate is too high).

Radio-frequency front-end circuitry can be tested using test equipment. During conventional testing operations, the test equipment generates a test signal that is provided to the radio-frequency front-end circuitry. The radio-frequency front-end circuitry subsequently conveys the test signal to the bit-based digital signal processing circuitry. The protocol-based physical layer processing circuitry then receives the test signals from the bit-based digital signal processing circuitry and computes a bit error rate to determine whether the radio-frequency front-end circuitry satisfies performance criteria. Characterizing radio-frequency circuitry by computing bit error rate using the protocol-based physical layer processing circuitry can be time consuming and lead to high manufacturing costs.

It would therefore be desirable to be able to provide improved test systems for wireless electronic devices.

### SUMMARY

A wireless electronic device may include storage and processing circuitry and wireless communications circuitry. The wireless communications circuitry may include radio-frequency front-end circuitry, digital demodulator circuitry (sometimes referred to as bit-based processing circuitry), and radio-frequency decoder circuitry (sometimes referred to as protocol-based processing circuitry).

A test system for testing the performance of a wireless electronic device may be provided that includes a test host (e.g., a personal computer) and a radio-frequency tester (e.g., a radio-frequency signal generator). The wireless electronic device currently being tested in the test system may be referred to as a device under test (DUT).

The test host may provide control signals to the tester to instruct the tester to generate radio-frequency test signals. The tester may generate the radio-frequency test signals using a selected wireless communications protocol (sometimes referred to as a radio access technology). The tester may generate the radio-frequency test signals using a selected digital modulation scheme. The radio-frequency test signals generated using a selected wireless communications protocol may be sometimes referred to as protocol encoded radio-frequency test signals. The test signals may be passed to the wireless communications circuitry in the DUT via a wired or wireless connection.

The radio-frequency front-end circuitry in the wireless communications circuitry may include amplifier circuitry, mixer circuitry, and conversion circuitry. The amplifier circuitry may amplify or attenuate the radio-frequency test signals received from the tester. The mixer circuitry may down-convert the received radio-frequency test signals to baseband frequency test data signals. The conversion circuitry may perform analog-to-digital conversion on the baseband frequency test data signals. The radio-frequency front-end circuitry may be subject to non-idealities (e.g., non-linearity, thermal noise, etc.). The radio-frequency front-end circuitry may pass the test data signals to the digital demodulator circuitry.

The digital demodulator circuitry may include transformation circuitry. The transformation circuitry may generate test data (sometimes referred to herein as performance data or radio-frequency data) using that reflects whether the DUT satisfies wireless performance criteria. The test data may be generated in response to receiving the radio-frequency test signals. The transformation circuitry may convert the received radio-frequency test signals from time-domain to frequency-domain to generate the test data. The transformation circuitry may include fast Fourier transform circuitry that performs at least one discrete Fourier transform on the test signals to create radio-frequency test data. The test signals may have in-phase and quadrature-phase components that are converted from time-domain to frequency-domain to generate the test data.

Generating the test data may also include generating noise floor data or signal-to-noise ratio data for the test signals. The signal-to-noise ratio data may be generated using the noise floor data. The test data may include frequency-domain performance data associated with the test signals. The digital demodulator circuitry operates on the test data signals received from the radio-frequency front-end circuitry without using the selected wireless communications protocol. The Fourier transform circuitry may perform Fourier transform operations on received communications protocol encoded radio-frequency test signals without decoding the communications protocol encoded radio-frequency test signals.

The frequency-domain performance data generated by the digital demodulator circuitry may be gathered by the test host for analysis. The test data signals that are not operated on by the transformation circuitry may be passed to the radio-frequency decoding circuitry. The radio-frequency decoding circuitry may process the received test data signals using the selected communications protocol.

The digital demodulator circuitry may generate data signals to be provided to the radio-frequency decoding circuitry by demodulating the received test signals using the selected digital modulation scheme (e.g., phase-shift keying (BPSK), Gaussian minimum shift-keying (GMSK), 8 phase shift keying (8PSK), etc.)

The radio-frequency decoding circuitry (sometimes referred to herein as protocol-based wireless communications circuitry, protocol-based processing circuitry) may generate additional test data based on the selected communications protocol. The additional test data may include error rate data that reflects whether the device under test satisfies wireless performance criteria. The radio-frequency decoding circuitry may decode the received test signals to obtain the additional test data using a radio access technology selected from the group consisting of: the Global System for Mobile Communications (GSM) protocol, the Code Division Multiple Access (CDMA) protocol, the Wideband Code Division Multiple Access (WCDMA) protocol, the “3G” Universal Mobile Telecommunications System (UMTS) protocol, and the “4G” Long Term Evolution (LTE) protocol.

The test host may perform pass-fail operations on the DUT by processing the frequency-domain performance data received from the bit-based processing circuitry. The test host may compute a performance metric associated with the test data signal using the frequency-domain performance data. For example, the test host may compute a noise floor associated with the test data signal. The test host may compare the noise floor to a predetermined threshold to characterize the performance of the wireless communications circuitry. The test host may also compute a signal-to-noise ratio associated with the test data signal. The test host may compare the signal-to-noise ratio with a predetermined threshold to characterize the performance of the wireless communications circuitry. Alternatively, the non-protocol based wireless communications circuitry may generate performance data that includes a signal-to-noise ratio or a noise floor associated with the performance data gathered by the test host.

Further features of the present invention, its nature and various advantages will be more apparent from the accompanying drawings and the following detailed description.

### BRIEF DESCRIPTION OF THE DRAWINGS

FIG. 1 is a schematic diagram of an illustrative electronic device with wireless communications circuitry in accordance with an embodiment of the present invention.

FIG. 2 is a diagram of an illustrative test system for testing a wireless electronic device in accordance with an embodiment of the present invention.

FIG. 3 is a diagram of an illustrative wireless electronic device under test having wireless communications circuitry that is coupled to a tester in accordance with an embodiment of the present invention.

FIG. 4 is a circuit diagram of illustrative radio-frequency circuitry coupled to antenna circuitry in a wireless electronic device in accordance with an embodiment of the present invention.

FIG. 5 is a plot showing the power level of a transmitted radio-frequency signal and an associated noise floor in accordance with an embodiment of the present invention.

FIG. 6 is a graph plotting signal-to-noise ratio as a function of bit error rate in accordance with an embodiment of the present invention.

FIG. 7 is a flow chart of illustrative steps for processing radio-frequency signals received from a tester in accordance with an embodiment of the present invention.

FIG. 8 is a flow chart of illustrative steps for instructing a tester to generate test signals that are provided to a wireless electronic device under test in accordance with an embodiment of the present invention.

### DETAILED DESCRIPTION

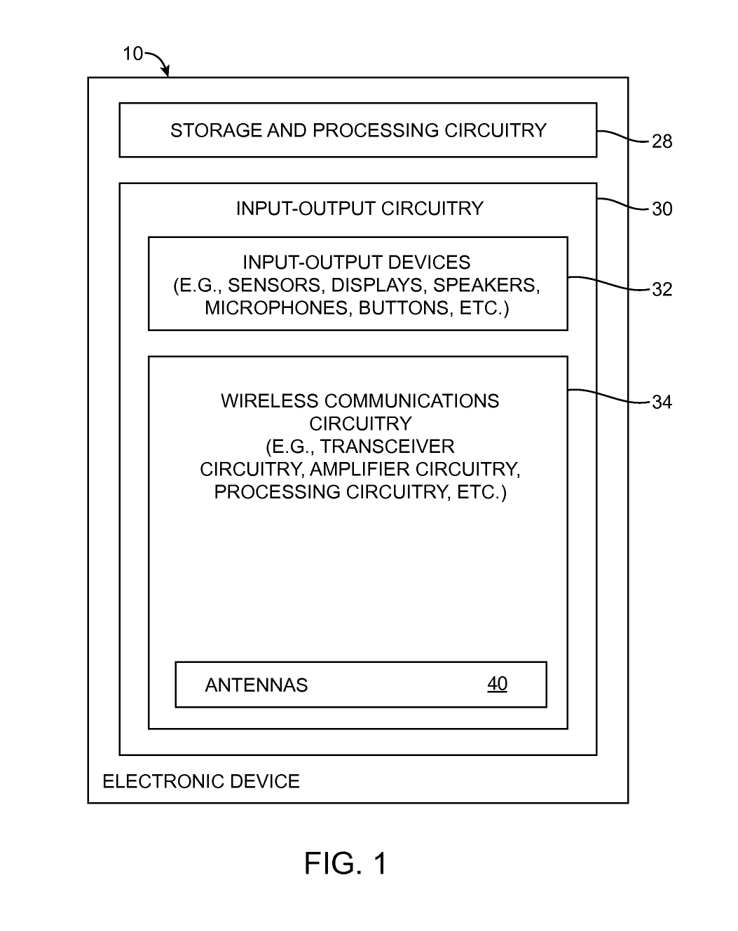

Electronic devices such as device 10 of FIG. 1 may be provided with wireless communications circuitry. The wireless communications circuitry may be used to support long-range wireless communications such as communications in cellular telephone bands. Examples of cellular telephone bands that may be handled by device 10 include the 800 MHz band, the 850 MHz band, the 900 MHz band, the 1800 MHz band, the 1900 MHz band, the 2100 MHz band, the 700 MHz band, and other bands. Other signals such as signals associated with satellite navigation bands may also be received by the wireless communications circuitry of device 10. For example, device 10 may use wireless circuitry to receive signals in the 1575 MHz band associated with Global Positioning System (GPS) communications. Short-range wireless communications may also be supported by the wireless circuitry of device 10. For example, device 10 may include wireless circuitry for handling local area network links such as WiFi® links at 2.4 GHz and 5 GHz, Bluetooth® links at 2.4 GHz, etc.

As shown in FIG. 1, device 10 may include storage and processing circuitry 28. Storage and processing circuitry 28 may include storage such as hard disk drive storage, nonvolatile memory (e.g., flash memory or other electrically-programmable-read-only memory configured to form a solid state drive), volatile memory (e.g., static or dynamic random-access-memory), etc. Processing circuitry in storage and processing circuitry 28 may be used to control the operation of device 10. This processing circuitry may be based on one or more microprocessors, microcontrollers, digital signal processors, application specific integrated circuits, etc.

Storage and processing circuitry 28 may be used to run software on device 10, such as internet browsing applications, voice-over-internet-protocol (VOIP) telephone call applications, email applications, media playback applications, operating system functions, functions related to communications band selection during radio-frequency transmission and reception operations, etc. To support interactions with external equipment, such as a radio-frequency base station or other radio-frequency equipment, storage and processing circuitry 28 may be used in implementing communications protocols. Communications protocols (sometimes referred to as radio access technologies) that may be implemented using storage and processing circuitry 28 include internet protocols, wireless local area network protocols (e.g., IEEE 802.11 protocols—sometimes referred to as WiFi®), protocols for other short-range wireless communications links such as the Bluetooth® protocol, IEEE 802.16 (WiMax) protocols, cellular telephone protocols such as the “2G” Global System for Mobile Communications (GSM) protocol, the “2G” Code Division Multiple Access (CDMA) protocol, the Wideband Code Division Multiple Access (WCDMA) protocol, the “3G” Universal Mobile Telecommunications System (UMTS) protocol, and the “4G” Long Term Evolution (LTE) protocol, MIMO (multiple input multiple output) protocols, antenna diversity protocols, etc. Wireless communications operations such as communications band selection operations may be controlled using software stored and running on device 10 (i.e., stored and running on storage and processing circuitry 28 and/or input-output circuitry 30).

Input-output circuitry 30 may include input-output devices 32. Input-output devices 32 may be used to allow data to be supplied to device 10 and to allow data to be provided from device 10 to external devices. Input-output devices 32 may include user interface devices, data port devices, and other input-output components. For example, input-output devices may include touch screens, displays without touch sensor capabilities, buttons, joysticks, click wheels, scrolling wheels, touch pads, key pads, keyboards, microphones, cameras, buttons, speakers, status indicators, light sources, audio jacks and other audio port components, digital data port devices, light sensors, motion sensors (accelerometers), capacitance sensors, proximity sensors, etc.

Input-output circuitry 30 may include wireless communications circuitry 34 for communicating wirelessly with external equipment. Wireless communications circuitry 34 may include radio-frequency (RF) transceiver circuitry formed from one or more integrated circuits, power amplifier circuitry, passive RF components, mixer circuitry, data conversion circuitry, one or more antennas, transmission lines, and other circuitry for handling RF wireless signals. Wireless signals can also be sent using light (e.g., using infrared communications).

Wireless communications circuitry 34 may include radio-frequency transceiver circuitry for handling various radio-frequency communications bands. For example, circuitry 34 may use cellular telephone transceiver circuitry for handling wireless communications in cellular telephone bands such as at 850 MHz, 900 MHz, 1800 MHz, 1900 MHz, and 2100 MHz and/or the LTE bands and other bands (as examples). Circuitry 34 may handle voice data and non-voice data traffic.

Wireless communications circuitry 34 may include one or more antennas 40. Antennas 40 may be formed using any suitable antenna types. For example, antennas 40 may include antennas with resonating elements that are formed from loop antenna structure, patch antenna structures, inverted-F antenna structures, slot antenna structures, planar inverted-F antenna structures, helical antenna structures, hybrids of these designs, etc. Different types of antennas may be used for different bands and combinations of bands. For example, one type of antenna may be used in forming a local wireless link antenna and another type of antenna may be used in forming a remote wireless link antenna.

Wireless communications circuitry 34 may include processing circuitry for processing wireless radio-frequency signals. For example, processing circuitry in communications circuitry 34 may include digital signal processing circuitry and communications protocol-based processing circuitry. The digital signal processing circuitry may include digital demodulation circuitry and the communications-based processing circuitry may include digital decoding circuitry.

Wireless communications circuitry 34 may be used to provide data to storage and processing circuitry 28. Data that is conveyed to circuitry 28 from wireless circuitry 34 may include raw and processed data. The processed data conveyed to circuitry 28 from wireless circuitry 34 may include data associated with wireless (antenna) performance metrics for received signals such as received power, transmitted power, frame error rate, bit error rate, channel quality measurements based on received signal strength indicator (RSSI) information, channel quality measurements based on received signal code power (RSCP) information, channel quality measurements based on reference symbol received power (RSRP) information, channel quality measurements based on signal-to-interference ratio (SINR) and signal-to-noise ratio (SNR) information, channel quality measurements based on signal quality data such as Ec/Io or Ec/No data, information on whether responses (acknowledgements) are being received from a cellular telephone tower corresponding to requests from the electronic device, information on whether a network access procedure has succeeded, information on how many re-transmissions are being requested over a cellular link between the electronic device and a cellular tower, information on whether a loss of signaling message has been received, information on whether paging signals have been successfully received, and other information that is reflective of the performance of wireless circuitry 34.

For example, storage and processing circuitry 28 may issue commands that direct wireless circuitry 34 to obtain a frequency-domain data signal associated with a signal-to-noise ratio of radio-frequency signals received from antennas 40. The processed data supplied by wireless circuitry 34 (e.g., the data associated with a performance metric) may be used to characterize the radio-frequency wireless performance of input-output circuitry 30. The data conveyed to circuitry 28 from wireless communications circuitry 34 may also be provided to external equipment such as external test equipment.

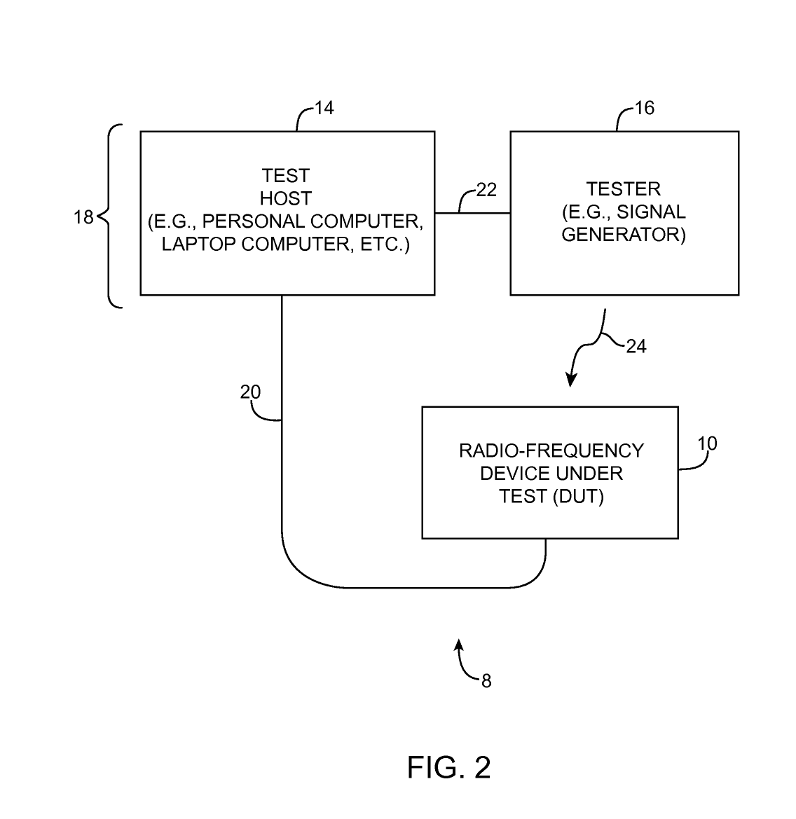

In accordance with an embodiment of the present invention, the performance of wireless communications circuitry 34 may be tested using a test system such as test system 8 of FIG. 2. As shown in FIG. 2, test system 8 may be used to perform radio-frequency testing on an electronic device such as electronic device 10. An electronic device 10 that is being tested using test system 18 may be referred to as a device under test (DUT).

Test system 8 may include a test host such as test host 14 (e.g., a personal computer, laptop computer, tablet computer, handheld computing device, etc.) and a tester such as tester 16. Test host 14 and tester 16 may be referred to collectively as test equipment 18. Tester 16 may include, for example, a signal generator that is capable of generating radio-frequency signals. Tester 16 may receive control signals from test host 14 over path 22 that instruct tester 16 to generate radio-frequency signals having particular characteristics. For example, test host 14 may provide control signals instructing tester 16 to generate radio-frequency signals having selected frequencies. Tester 16 may generate radio-frequency signals having one frequency or a number of different frequency components. Tester 16 may also generate a sequence of radio-frequency signals each having different frequencies (e.g., tester 16 may generate a first radio-frequency signal at a first frequency during a first period of time and a second radio-frequency signal at a second frequency during a second period of time).

Tester 16 may provide radio-frequency signals to electronic device under test (DUT) 10 over path 24. Radio-frequency signals that are provided to DUT 10 by tester 16 are sometimes referred to herein as radio-frequency test signals. Radio-frequency test signals generated by tester 16 may have baseband frequency components and carrier frequency components. For example, test signals generated by tester 16 may be data signals (e.g., signals with a baseband frequency) that are mixed with carrier signals (e.g., signals with a radio frequency). Mixing carrier signals with data signals to generate test signals using tester 16 may include modulating the carrier signal with the data signal. Modulating the carrier signal with the data signal may include any suitable type of carrier signal modulation (e.g., amplitude modulation, frequency modulation, phase modulation, etc.).

Data signals generated by tester 16 may be encoded using any suitable communications protocol (e.g., the “2G” Global System for Mobile Communications (GSM) protocol, the “2G” Code Division Multiple Access (CDMA) protocol, the Wideband Code Division Multiple Access (WCDMA) protocol, the “3G” Universal Mobile Telecommunications System (UMTS) protocol, the “4G” Long Term Evolution (LTE) protocol, etc.). Data signals generated by tester 16 may be digitally modulated using any suitable digital modulation scheme (e.g., binary phase-shift keying (BPSK), Gaussian minimum shift-keying (GMSK), 8 phase shift keying (8PSK), 16 phase quadrature amplitude modulation, etc.).

Tester 16 may sequentially produce a number of test signals each having respective baseband and carrier frequencies. For example, during a first time period, tester 16 may produce a first test signal by modulating a first data signal having a first baseband frequency with a first carrier signal having a first carrier frequency. During a second time period, tester 16 may produce a second test signal by modulating a second data signal having a second baseband frequency with a second carrier signal having a second carrier frequency.

In one suitable arrangement, path 24 is formed as a wired connection (e.g., a radio-frequency transmission line, coaxial cable, etc.) over which radio-frequency test signals are supplied to DUT 10. In another suitable arrangement, tester 16 wirelessly provides test signals over path 24 to antennas 40 in DUT 10. DUT 10 may process received test signals using wireless communications circuitry 34. Processing received test signals may include extracting data signals from the received test signals. Extracting data signals from the received test signals may include demodulating the data signals and the carrier signals in the received test signals. The processed data signals may then be analyzed to determine resulting wireless performance metrics (e.g., signal-to-noise ratio, bit error rate, etc.).

For example, DUT 10 may provide the processed data signals to test host 14 over path 20. Test host 14 may analyze the processed data signals received from DUT 10 to characterize the radio-frequency performance of wireless circuitry 34 in DUT 10. For example, test host 14 may characterize the radio-frequency performance of wireless circuitry 34 as either unacceptable or acceptable based on one or more of the performance metrics associated with the processed data signals received from DUT 10.

Test system 18 of FIG. 2 is merely illustrative. If desired, the baseband frequency with which test signals are generated may be a range of baseband frequencies having a bandwidth, whereas the carrier frequency with which test signals are generated may be a range of carrier frequencies having a bandwidth. Multiple baseband frequencies or frequency ranges and multiple carrier frequencies or frequency ranges may be used to generate test signals with suitable characteristics during testing operations.

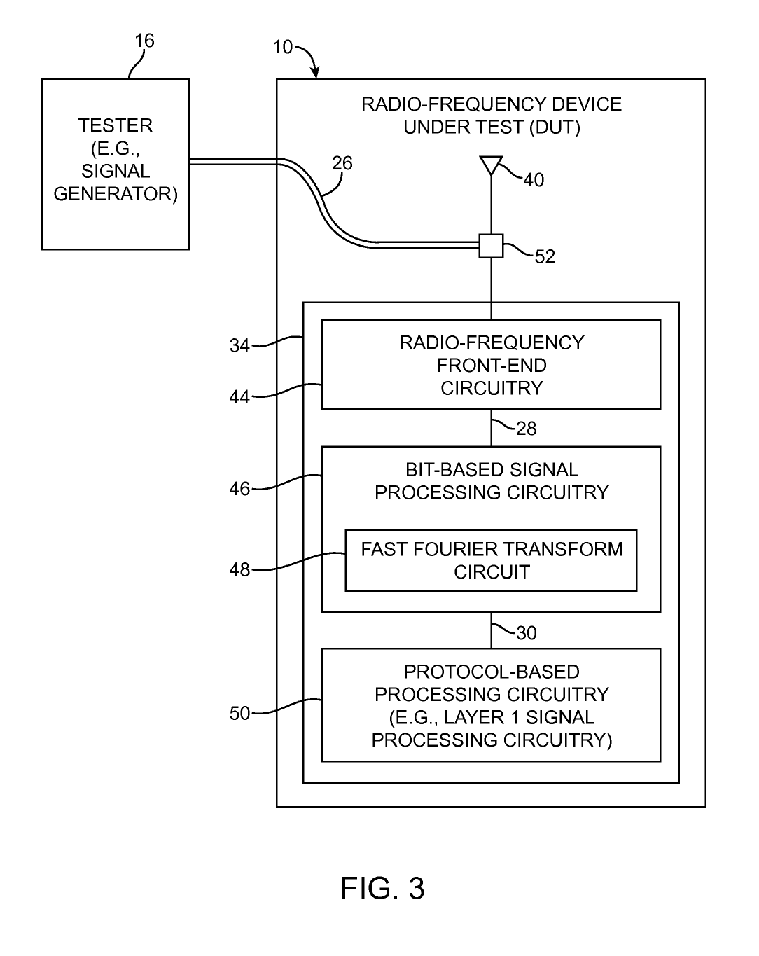

During testing, tester 16 may be coupled to radio-frequency connector 52 in DUT 10 via radio-frequency test cable 26 in accordance with an embodiment of the invention (see, e.g., FIG. 3). Radio-frequency connector 52 may be interposed in a transmission line path between antenna 40 and wireless circuitry 34. When mated with test cable 26, antenna 40 may be decoupled from wireless communications circuitry 34. At the same time, radio-frequency connector 52 may electrically connect circuitry 34 and tester 16 via path 26. In this way, radio-frequency test signals transmitted by tester 16 over line 26 can be passed to wireless circuitry 34 during testing. Connector 52 used to bypass DUT antenna 40 may sometimes be referred to as a switch connector.

Wireless circuitry 34 may include radio-frequency front-end circuitry 44. Radio-frequency front-end circuitry 44 may receive analog radio-frequency test signals from tester 16 via transmission line 26 and connector 52. Radio-frequency front-end circuitry 44 may include, for example, amplifier circuitry, mixer circuitry, converter circuitry, and other suitable components for processing received radio-frequency signals. Front-end circuitry 44 may have components such as mixer circuitry that serve to remove the carrier signal from the test signals in a process sometimes referred to herein as down-conversion. Down-converting test signals may include removing the radio-frequency carrier signals from the test signals to extract baseband data signals (e.g., front-end circuitry 44 may demodulate the data and carrier signals). Converter circuitry in front-end circuitry 44 may convert received analog test signals to digital test signals. The converter circuitry in front-end circuitry 44 may perform analog-to-digital conversion on data signals that have been extracted from the received test signals.

The data signals received from front-end circuitry 44 may be encoded and digitally modulated data signals. When data signals are generated by tester 16, the data signals may be encoded based on a selected communications protocol (e.g., GSM protocol, WCDMA protocol, etc.) and modulated based on a selected digital modulation scheme. Data signals generated by tester 16 may be modulated using any suitable digital modulation scheme (e.g., binary phase-shift keying (BPSK), Gaussian minimum shift-keying (GMSK), 8 phase shift keying (8PSK), 16 phase quadrature amplitude modulation, etc.). The selected communications protocol provides a standard to tester 16 for encoding groups of bits in the generated data signals so that each group of bits corresponds to a respective digital symbol. Protocol-based processing circuitry such as protocol-based processing circuitry 50 (sometimes referred to as radio-frequency decoding circuitry) may decode digital data signals using the standards associated with the selected communications protocol to convert encoded groups of bits in the received data signals to the corresponding digital symbols.

Bit-based processing circuitry such as bit-based signal processing circuitry 46 (sometimes referred to as digital demodulation circuitry or digital demodulator circuitry) may process encoded data signals without using the standard given by the selected communications protocol. Bit-based processing circuitry 46 may perform digital demodulation on the encoded data signals. Bit-based signal processing circuitry 46 may receive digital data signals from radio-frequency front-end circuitry 44 via line 28. Data signals received by circuitry 46 may include in-phase and quadrature phase (I/Q) components. A data signal may be represented in polar space as in-phase (I) and quadrature phase (Q) components. The amplitude of a data signal may be expressed in I/Q space components as shown by the following equation:

AMPLITUDE=SQRT(I²+Q²) (1)

where SQRT( ) indicates the square root function. The phase of a data signal may be expressed in I/Q space components as shown by the following equation:

PHASE=arctan(Q/I) (2)

where arctan( ) represents the arctangent function. Equations 1 and 2 may be used to convert amplitude and phase of the received data signals to I/Q space data (i.e., from an amplitude/phase representation of the data to an I/Q representation of the data).

Bit-based signal processing circuitry 46 may process data signals received from front-end circuitry 44 by performing operations (e.g., logic operations, arithmetic operations, domain transformations, etc.) on the received data signals. Bit-based signal processing circuitry 46 may also process the received data signals by performing operations on I/Q data associated with the received data signals. For example, bit-based circuitry 46 may perform mathematical algorithms (e.g., a series of data transformations) on the associated I/Q data. Bit-based processing circuitry 46 may process the received data signals without decoding digital symbols encoded by tester 16 during data signal generation using the selected communications protocol. Bit-based processing circuitry 46 may perform digital demodulation on the I/Q data to produce a binary data bit stream (e.g., a sequence of binary “1” and “0”). The binary data bit stream may be passed to protocol-based processing circuitry 50.

Data signals received by bit-based signal processing circuitry 46 may be represented in a time-domain. For example, data signals may be represented by a waveform that varies in time at one or more frequencies. Data signals received by bit-based circuitry 46 may have an associated frequency-domain representation. For example, a frequency-domain representation of the received data signals may be a waveform that varies with respect to frequency for a given time interval. The frequency-domain representation of the received data signals may illustrate a frequency spectrum of the corresponding time-domain data signals. Data signals received from tester 16 are processed as time-domain signals by front-end circuitry 44.

Bit-based processing circuitry 46 may include a fast Fourier transform (FFT) circuit 48. Fast Fourier transform circuit 48 may perform time-domain to frequency-domain transformations on data signals received from front-end circuitry 44. Fast Fourier transform circuit 48 may be formed using circuitry or any other suitable means for performing time-to-frequency domain transformations such as fast Fourier transforms on received data signals. Fast Fourier transforms performed by FFT circuit 48 may transform received data signals from time-domain data signals to frequency-domain data signals. FFT circuit 48 may transform received data signals by computing discrete Fourier transforms of the received data signals. FFT circuit 48 may compute discrete Fourier transforms of the I/Q data associated with received data signals or both the received data signals and the associated I/Q data. Fast Fourier transforms may be performed using any suitable FFT algorithm (e.g., a Cooley-Tukey FFT algorithm, prime-factor FFT algorithm, Bruun's FFT algorithm, Rader's FFT algorithm, etc.).

Frequency-domain data signals produced by FFT circuit 48 may be passed to test host 14 via path 20 for analysis and characterization (see FIG. 2). Data signals that are processed by bit-based signal processing circuitry 46 may also be passed to protocol-based processing circuitry 50 via path 30. Binary data bit streams that are produced by performing digital demodulation on the I/Q data with bit-based processing circuitry 46 may be passed to protocol-based processing circuitry 50. Protocol-based processing circuitry 50 may include circuitry such as “layer 1” signal processing circuitry (sometimes referred to as the “physical layer” of the Open Systems Interconnection (OSI) model). Protocol-based processing circuitry 50 may process received data signals (e.g., binary data bit streams received from bit-based processing circuitry 46) using the selected communications protocol with which tester 16 encoded the data signals. The selected communications protocol may provide a standard for circuitry 50 to decode received data signals. For example, the selected communications protocol may instruct protocol-based circuitry 50 to decode digital symbols in the received data signals that were encoded by tester 16 using the selected communications protocol.

Data signals received by bit-based processing circuitry 46 from front-end circuitry 44 may be associated with performance metrics such as signal-to-noise ratio (SNR) and bit error rate. Obtaining a bit error rate of a received data signal includes determining a number of erroneous bits in the received data signal. A given bit may be determined to be erroneous by comparing the received data signal with the corresponding test signal that is supplied to front-end circuitry 44 by tester 16 (e.g., the corresponding test signal from which the received data signal is extracted by front-end circuitry 44). If a given bit in the received data signal does not match the corresponding bit in the corresponding test signal, the given bit may be referred to as an erroneous bit. The proportion of erroneous bits to non-erroneous bits in the received data signal may determine the bit error rate. Circuitry that decodes the binary data bit streams using a selected communications protocol such as protocol-based processing circuitry 50 may generate error rate data such as bit error rate data associated with the received data signal.

Non-idealities (e.g., amplifier noise, amplifier non-linearity, etc.) in front-end circuitry 44 may cause a given bit in the received data signal to be erroneous. The bit error rate may be used to characterize the performance of radio-frequency front-end circuitry 44. For example, if there is an undesirable number of erroneous bits in the received data signal, front-end circuitry 44 may be characterized by insufficient radio-frequency performance. Data signals that are processed by protocol-based processing circuitry 50 may be subsequently passed to other circuitry in DUT 10.

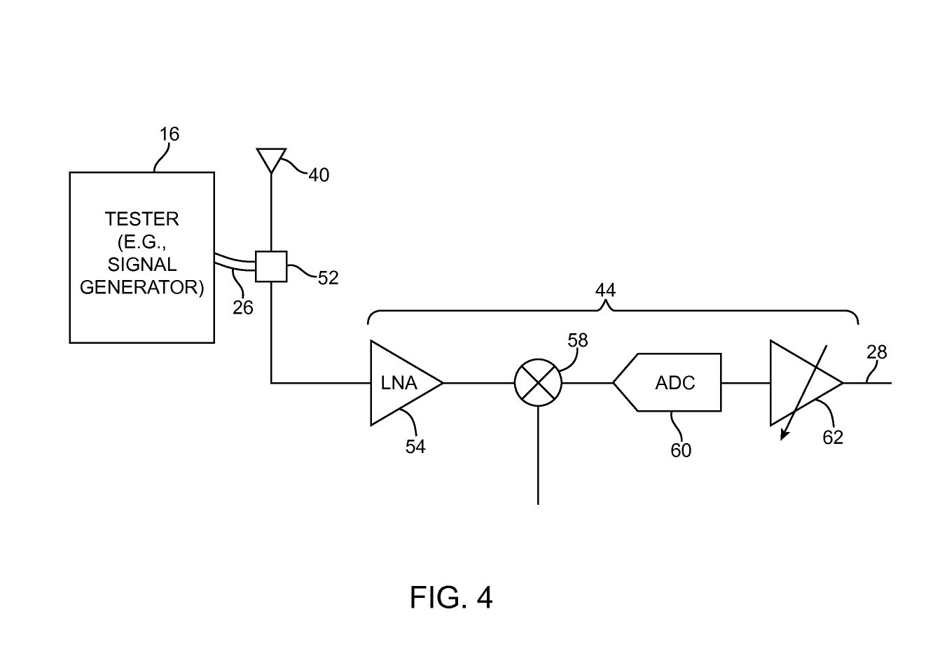

FIG. 4 shows a circuit diagram of illustrative radio-frequency front-end circuitry that can be characterized using a suitable performance metric. As shown in FIG. 4, radio-frequency front-end circuitry 44 may include amplifier circuitry such as low-noise amplifier (LNA) 54 that receives radio-frequency test signals from tester 16 via switch connector 52. The received radio-frequency test signals may be analog test signals. Low-noise amplifier 54 may amplify the radio-frequency test signals received from connector 52. LNA 54 may output amplified radio-frequency test signals to mixer circuitry such as mixer 58. Mixer 58 may remove carrier signals from the amplified radio-frequency test signals by demodulating the carrier signals and the data signals. In this way, mixer 58 may down-convert amplified test signals to baseband frequency test signals.

Mixer 58 may output baseband frequency test signals to an input of converter circuitry such as analog-to-digital converter (ADC) circuitry 60. ADC circuitry 60 may convert analog test signals received from mixer 58 to digital test data signals. ADC circuitry 60 may be formed using any suitable conversion circuitry to perform analog-to-digital conversion on data signals received from mixer 58. For example, ADC circuitry 60 may be formed using direct-conversion ADC architecture, successive-approximation ADC architecture, ramp-compare ADC architecture, integrating ADC architecture, etc. ADC circuitry 60 may output digital test data signals to an input of amplifier circuitry such as digital variable gain amplifier (DVGA) 62. DVGA 62 may be used to attenuate the digital test data signals received from ADC circuitry 60. The amount of attenuation may be adjustable so that received digital data signals are provided with a suitable gain. Data signals amplified by DVGA 62 may be supplied to bit-based processing circuitry 46 via path 28 (FIG. 3).

Front end circuitry 44 of FIG. 4 is merely illustrative. If desired, any number and combination of amplifiers, mixers, converters and other suitable circuitry may be formed to process radio-frequency signals received from tester 16. For example, front-end circuitry 44 may be formed with multiple LNAs 54 to suitably amplify received radio-frequency test signals. Similarly, multiple DVGAs 62 may be formed for providing a suitable gain to digital test data signals received from ADC circuitry 60.

The performance of front-end circuitry 44 may be subject to non-idealities. For example, LNA 54, ADC circuitry 60, and DVGA 62 may be subject to non-linearity and signal noise (e.g., thermal noise) that can distort the digital test data signals provided to bit-based processing circuitry 46. The noise generated by front-end circuitry 44 can potentially cause bit-based processing circuitry 46 to receive erroneous data signals. For example, an excessive amount of noise may create an undesirable number of erroneous bits in data signals received by bit-based processing circuitry 46. Excessive noise may limit the ability of bit-based processing circuitry 46 to distinguish between data signals generated by tester 16 and noise generated by front-end circuitry 44.

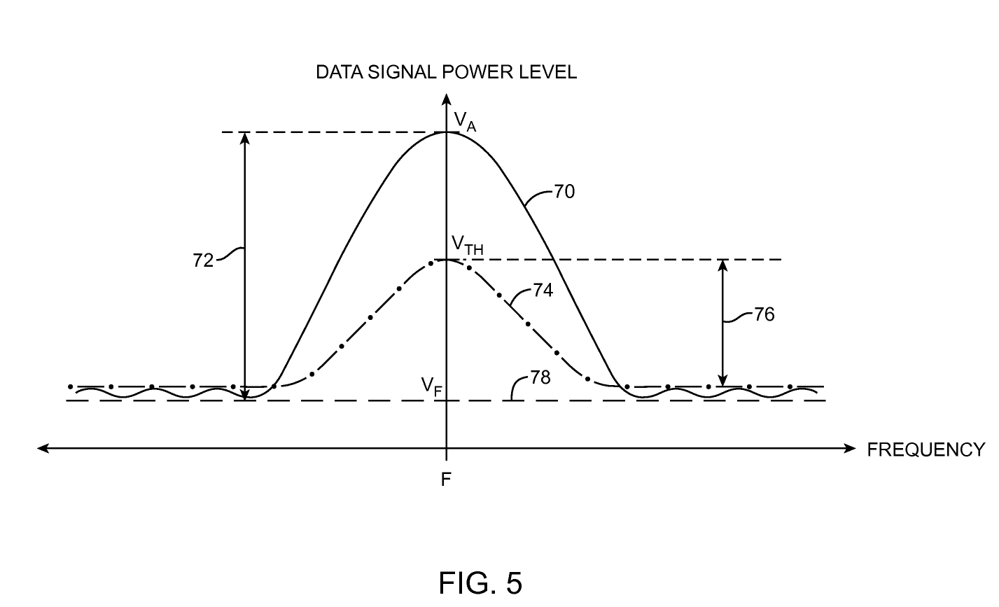

FFT circuit 48 in bit-based processing circuitry 46 may perform fast Fourier transforms on data signals received from front-end circuitry 44 to convert the data signals from time-domain data signals to frequency-domain data signals. A graph showing how the power level of a data signal received by bit-based processing circuitry 46 may vary as a function of frequency for different values of signal-to-noise ratio is shown in FIG. 5. Curve 70 is a frequency-domain representation of a data signal received from front-end circuitry 44. Curve 70 may be generated by FFT circuit 48 after performing a fast Fourier transform on the time-domain data signal received from front-end circuitry 44. In particular, curve 70 represents the power level of the received data signal as a function of frequency, with a peak magnitude V_{A} centered at a frequency F (e.g., a baseband frequency F at which the data signal was generated by tester 16).

Curve 70 has a noise floor with a power level V_{F} as indicated by dashed line 78. Noise floor 78 of curve 70 may represent noise in the data signal that is not associated with the test signal generated by tester 16. Noise floor 78 may be produced as a result of non-idealities in front-end circuitry 44. Peak power level V_{A} may be greater than noise floor power level V_{F} by a signal range 72. Signal range 72 determines a signal-to-noise ratio (SNR) of the data signal represented by curve 70. As an example, if signal range 72 is large the SNR of the data signal represented by curve 70 may be high. Alternatively, if signal range 72 is small, the SNR of the data signal represented by curve 70 may be low.

Curve 74 represents the power level of a data signal centered at peak frequency F and having a peak magnitude V_{TH} that is less than peak power level V_{A} associated with curve 70. Curve 74 has a common noise floor 78 with curve 70. Peak power level V_{TH} may be greater than noise floor power level V_{F} by a second signal range 76 that is less than first signal range 72. Signal range 76 determines an SNR of the data signal associated with curve 74. The SNR of the data signal associated with curve 74 is less than the SNR of the data signal associated with curve 70. The data signal represented by curve 70 thereby has a greater SNR than the data signal represented by curve 74.

It may be more difficult for bit-based processing circuitry 46 to distinguish between the data signal generated by tester 16 and noise created by front-end circuitry 44 when receiving a data signal associated with curve 74 than when receiving a data signal associated with curve 70. The noise created by front-end circuitry 44 may result in a high number of erroneous bits in the data signal associated with curve 74 when received by bit-based processing circuitry 46. The data signal associated with curve 74 may have an insufficient SNR for bit-based processing circuitry 46 to accurately distinguish between the data signal generated by tester 16 and the noise created by front-end circuitry 44. Curve 74 may illustrate a threshold SNR below which data signals may have an unacceptable number of erroneous bits. Curve 70 illustrates a data signal that has an acceptably low number of erroneous bits and an acceptable bit error rate because the SNR of the data signal associated with curve 70 is greater than the threshold SNR of the data signal associated with curve 74 at peak frequency F.

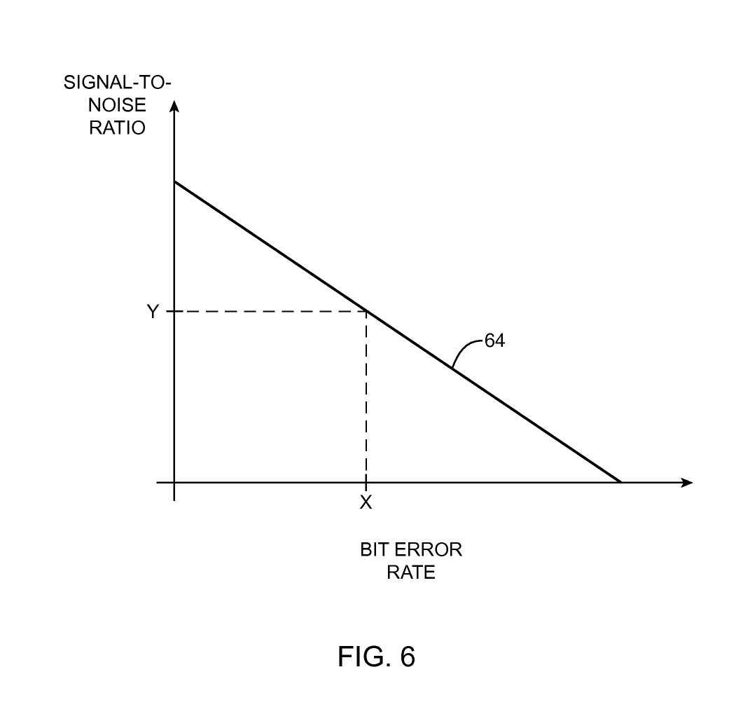

The performance of front-end circuitry 44 may be characterized using the SNR of data signals received from front-end circuitry 44 based on a correlation between SNR and bit error rate. A plot showing how signal-to-noise ratio may vary with bit error rate is shown in FIG. 6. Line 64 illustrates an inversely proportional linear correlation between SNR and bit error rate. In the example of FIG. 6, the SNR of data signals received by bit-based processing circuitry 46 decreases as the associated bit error rate increases (e.g., a high SNR is associated with a low bit error rate and a low SNR is associated with a high bit error rate). As the SNR decreases, the data signals may become more heavily influenced by noise causing the number of erroneous bits and the bit error rate to increase.

Because bit error rate correlates well with SNR (e.g., the correlation indicated by line 64), the performance of front-end circuitry 44 can be effectively determined by monitoring SNR instead of bit error rate. For example, radio-frequency performance standards may require data signals supplied by front-end circuitry 44 to have a bit error rate that is less than bit error rate threshold X. The radio-frequency performance standards may be, for example, carrier-imposed requirements, manufacturing requirements, or any other suitable standards for wireless performance of wireless circuitry 34. The radio-frequency performance standards may sometimes be referred to as wireless performance criteria.

The correlation of line 64 may be used to determine whether the SNR of the data signals processed by FFT circuit 48 corresponds to a bit error rate that is greater than or less than bit error rate threshold X. The SNR value that corresponds to bit error rate threshold X may be referred to as SNR threshold Y. If the frequency-domain data signal has an SNR value (as computed using FFT circuit 48) that is greater than SNR threshold Y (e.g., if the SNR value corresponds to a bit error rate that is less than bit error rate threshold X), then the associated data signals may have sufficient SNR and the performance of front-end circuitry 44 may be characterized as acceptable. If the frequency-domain data signal has an SNR value that is less than SNR threshold Y (e.g., if the SNR value corresponds to a bit error rate that is greater than bit error rate threshold X), then the associated data signals may have insufficient SNR and the performance of front-end circuitry 44 may be characterized as unacceptable.

Frequency-domain data signals produced by FFT circuit 48 when operating on data signals received from front-end circuitry 44 (e.g., data signals associated with curve 70 of FIG. 5) may be passed to test host 14 via line 20 for processing and analysis (FIG. 2). Test host 14 may analyze the frequency-domain data signals to produce performance metric data (e.g., signal-to-noise ratio values). The performance metric data may be compared to performance standards (e.g., bit error rate requirements) to characterize the performance of front-end circuitry 44. For example, test host 14 may characterize front-end circuitry 44 by calculating the SNR of frequency-domain data signals received from bit-based processing circuitry 46. Test host 14 may subsequently compare the calculated SNR to a known correlation with bit error rate (e.g., the correlation associated with line 64 of FIG. 6).

Test host 14 may perform this analysis on any number of frequency-domain data signals received from DUT 10. For example, test host 14 may analyze data signals corresponding to test signals generated by tester 16 using various configurations of carrier frequency and baseband frequency. In this way, test host 14 may test the performance of front-end circuitry 44 when subject to test signals having a number of different radio frequencies.

In another suitable arrangement, bit-based processing circuitry 46 includes circuitry to analyze the frequency-domain data signals produced by FFT circuit 48. Bit-based processing circuitry 46 may determine any suitable performance metric data such as SNR data, noise floor data, thermal noise data, etc. Bit-based processing circuitry 46 may pass the performance metric data to test host 14 for further analysis.

In yet another suitable arrangement, frequency-domain data signals produced by FFT circuit 48 are passed to storage and processing circuitry 28 in DUT 10 (FIG. 1). Storage and processing circuitry 28 may include circuitry to analyze frequency-domain data signals received from FFT circuit 48. Storage and processing circuitry 28 may determine performance metric data such as SNR data, noise floor data, thermal noise data, etc. Storage and processing circuitry 28 may pass the performance metric data to test host 14 for further analysis.

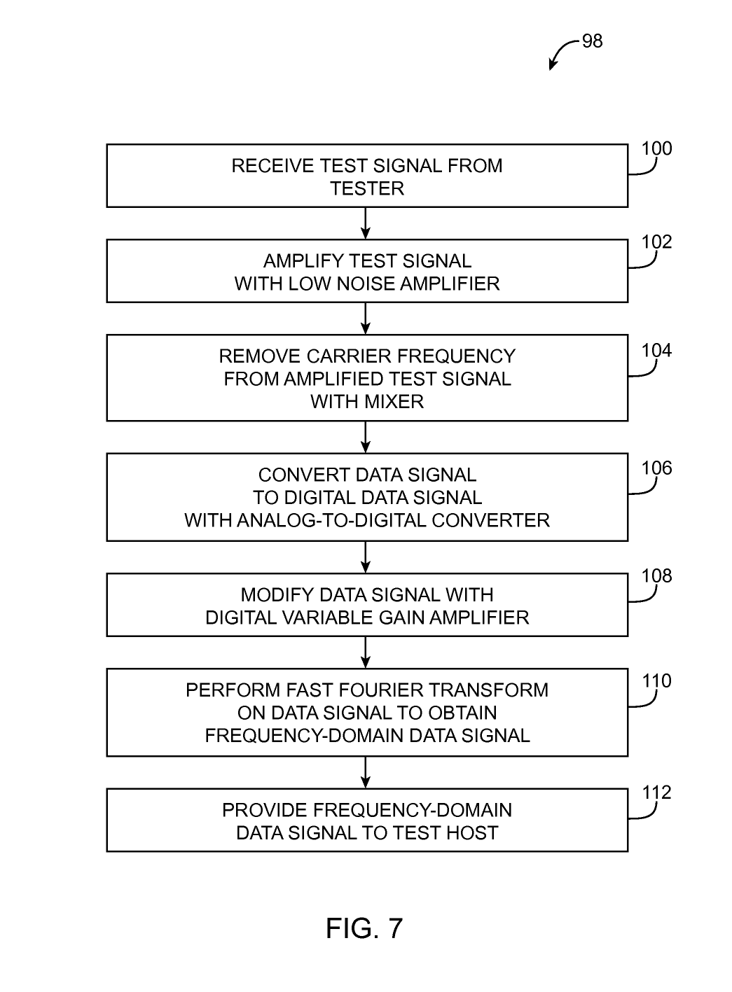

A flow chart 98 of illustrative steps that may be performed by an electronic device under test such as DUT 10 to process test signals received from tester 16 is shown in FIG. 7.

At step 100, DUT 10 receives a radio-frequency test signal from tester 16 via path 24 (see FIG. 3). The radio-frequency test signal received from tester 16 may have a selected radio frequency. The received radio-frequency test signal may be subsequently conveyed to front-end circuitry 44 for radio-frequency processing.

At step 102, the received radio-frequency test signal is passed to low-noise amplifier 54 in front-end circuitry 44 as shown in FIG. 4. Low-noise amplifier 54 may amplify the received radio-frequency test signal. Low-noise amplifier 54 may have a fixed gain or a variable gain for amplifying the received radio-frequency test signal. The amplified radio-frequency test signal may be subsequently passed to mixer 58.

At step 104, mixer 58 down-converts the amplified radio-frequency test signal to a baseband frequency test signal. After down-converting the radio-frequency test signal, mixer 58 may subsequently pass the baseband frequency test signal to analog-to-digital (ADC) converter circuitry 60 for data conversion.

At step 106, ADC circuitry 60 converts the baseband frequency test signal received from mixer 58 into a digital test data signal. The digital data signal may include a data stream of data bits that form a digital representation of the extracted data signal. The data stream of digital bits may include communications protocol encoded digital symbols. The digital data signals may have in-phase and quadrature phase (I/Q data) components. ADC circuitry 60 may subsequently pass the digital data signal to digital variable gain amplifier (DVGA) 62.

At step 108, DVGA 62 attenuates the digital data signal received from ADC circuitry 60. The gain of DVGA 62 may be adjusted to provide the digital data signal with a suitable attenuation. Alternatively, a fixed gain amplifier may be used instead of DVGA 62. DVGA 62 may subsequently convey the attenuated data signal to bit-based signal processing circuitry 46 via path 28. The data signal that is conveyed to bit-based processing circuitry 46 may have signal noise as a result of non-idealities in front-end circuitry 44 (e.g., amplifier non-linearity, thermal noise, etc.).

At step 110, bit-based processing circuitry 46 operates on the digital data signal received from front-end circuitry 44 with fast Fourier transform (FFT) circuit 48. FFT circuit 48 may perform fast Fourier transforms on the data signal to convert the data signal from a time-domain data signal to a frequency-domain data signal, such as the frequency-domain data signal illustrated by curves 70 and 74 in FIG. 5. FFT circuit 48 may perform fast Fourier transforms on the digital data signal and/or the I/Q components of the digital data signal. Bit-based processing circuitry 46 may perform digital demodulation on the I/Q components of the digital data signal before or after FFT circuitry 48 performs fast Fourier transforms on the digital data signal and/or the associated I/Q components. Bit-based processing circuitry 46 may perform digital demodulation using any suitable digital modulation scheme (e.g., BPSK, GMSK, 8PSK, etc.). Bit-based processing circuitry 46 may operate on the digital data signal received from front-end circuitry 44 without decoding digital symbols encoded by tester 16 using a selected communications protocol.

The frequency-domain data signal may be centered at a peak frequency F (see FIG. 5). Peak frequency F may be the frequency of the baseband data signal as generated by tester 16. The frequency-domain data signal may be subsequently conveyed to test host 14 via line 20 for further processing as shown in FIG. 2 (step 112). The frequency-domain data signal may contain signal noise. The signal noise may be illustrated by a noise floor such as noise floor 78 of FIG. 5. Bit-based processing circuitry 46 may also convey frequency-domain data signals and time-domain data signals that are not operated on by FFT circuit 48 to protocol-based processing circuitry 50 via path 30 (FIG. 3).

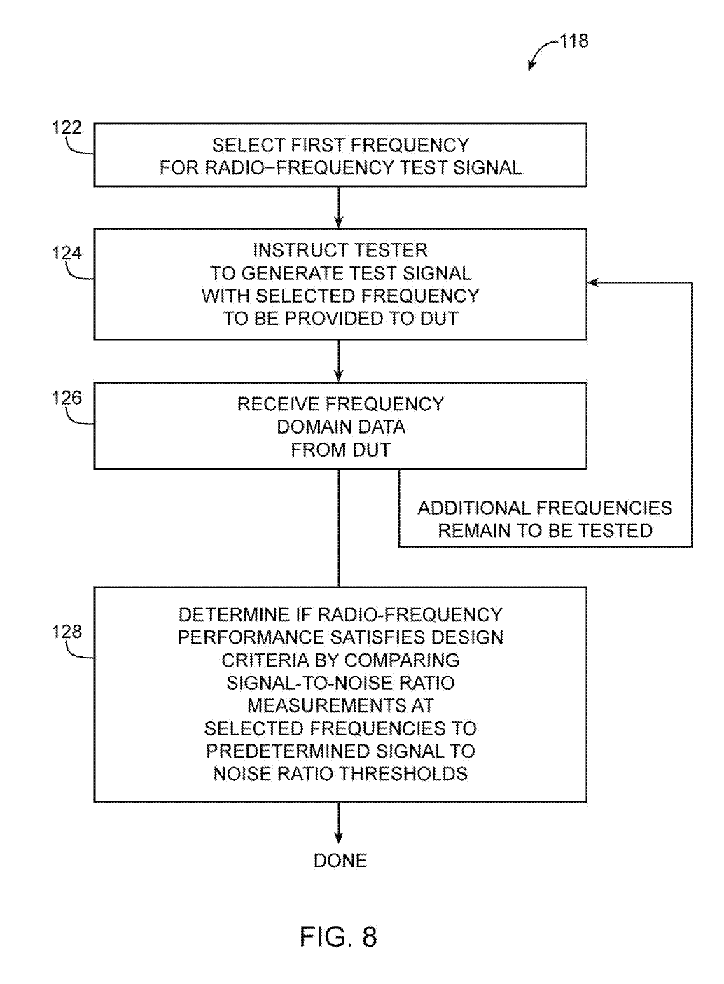

A flow chart 118 of illustrative steps that may be performed by a test host such as test host 14 of FIG. 2 to characterize the radio-frequency performance of wireless circuitry 34 is shown in FIG. 8.

At step 122, test host 14 selects a first frequency with which to generate a radio-frequency test signal. The first frequency may be any suitable radio frequency (e.g., 3 KHz, 10 KHz, 10 MHz, 1 GHz, etc.).

At step 124, test host 14 instructs tester 16 to generate a test signal with the selected radio frequency. Test host 14 may instruct tester 16 to generate a test signal with the selected first frequency for a first period of time. Tester 16 may generate the test signal by mixing a carrier signal with a baseband data signal. Mixing the carrier signal with the baseband data signal may include modulating the carrier signal with the data signal. The baseband data signal may be encoded using a selected communications protocol (e.g., CDMA, WCDMA, LTE, etc.) and digitally modulated using a selected digital modulation scheme (e.g., BPSK, GMSK, 8PSK, etc.). Test host 14 may subsequently instruct tester 16 to provide the radio-frequency test signal to DUT 10.

At step 126, test host 14 receives frequency-domain test data from DUT 10 via path 20 (e.g., frequency-domain data produced by wireless circuitry 34 using the steps of flow chart 98 of FIG. 7). The received frequency-domain test data may be a frequency-domain data signal. The received frequency-domain data signal may be a frequency-domain representation of the baseband data signal that was conveyed to DUT 10 by tester 16 after being processed by front-end circuitry 44 and bit-based processing circuitry 46. The frequency-domain data signal received from DUT 10 may be stored in test host 14 for analysis.

In another suitable arrangement, the frequency-domain test data received by test host 14 includes performance metric data such as signal-to-noise ratio values that are calculated by DUT 10. The signal-to-noise ratio values may be calculated in storage and processing circuitry 28 or in bit-based processing circuitry 46 before being received by test host 14.

Processing may proceed to step 124 to test the radio-frequency performance of DUT 10 using radio-frequency test signals with having different selected frequencies. For example, test host 14 may instruct tester 16 to generate additional radio-frequency test signals at additional frequencies to be provided to DUT 10 for additional time periods. The frequency-domain data signals received from DUT 10 in response to the additional test signals may be stored by test host 14. In this way, the performance of front-end circuitry 44 may be tested for radio-frequency test signals having a number of different frequencies. In addition, test signals with other variable properties such as output power may be provided. Processing may proceed to step 128 if no frequencies remain to be provided to DUT 10.

At step 128, test host 14 processes each frequency-domain data signal received from DUT 10 during step 126. Test host 14 may compute performance metric data based on the received frequency-domain data signals with which to characterize the performance of front-end circuitry 44. Computing performance metric data may include computing a noise floor of the received frequency-domain data signals such as noise floor 78 of FIG. 5. The computed noise floor may be used by test host 14 to compute a corresponding SNR associated with each of the received frequency-domain data signals. Each SNR may be computed using a signal range that is determined by subtracting the respective noise floor from a respective peak power level. In the example of FIG. 5, the SNR of data signals associated with curve 70 may be computed by determining a signal range 72 by subtracting noise magnitude V_{F} from peak power level V_{A}.

Test host 14 may compare the computed SNR to bit error rate using a known correlation between SNR and bit error rate, such as the correlation shown by line 64 of FIG. 6. The bit error rate may include a bit error rate threshold below which the bit error rate may be determined to be acceptable and above which the bit error rate may be determined to be unacceptable. In the example of FIG. 6, a bit error rate that is greater than bit error rate threshold X is determined to be an unacceptable bit error rate. The bit error rate threshold may have a corresponding SNR threshold. If the computed SNR is above the SNR threshold, the SNR ratio may be determined to be sufficient. If the computed SNR is below the SNR threshold, the SNR may be determined to be insufficient. In the example of FIG. 6, an SNR that is greater than SNR threshold Y is determined to be a sufficient SNR.

A computed SNR that is determined to be sufficient (e.g., a computed SNR that is greater than the SNR threshold) characterizes acceptable performance of front-end circuitry 44. Similarly, a computed SNR that is determined to be insufficient characterizes unacceptable performance of front-end circuitry 44. If the performance of front-end circuitry 44 is determined to be unacceptable, the unacceptable front-end circuitry 44 may be marked as a failing component and/or the corresponding DUT 10 may be marked as a failing DUT. If the performance of front-end circuitry 44 is determined to be acceptable, front-end circuitry 44 may be marked as a passing component and/or the corresponding DUT 10 may be marked as a passing DUT. Front end circuitry 44 may be considered a failing component if front-end circuitry 44 has unacceptable performance for radio-frequency test signals at one or more frequencies. Determining passing and failing components may sometimes be referred to as performing pass-fail operations with test host 14.

In another suitable arrangement, test host 14 may compare performance metric data received from storage and processing circuitry 28 or bit-based processing circuitry 46 in DUT 10 to performance standards. For example, test host 14 may compare SNR values computed by storage and processing circuitry 28 or bit-based processing circuitry 46 to SNR threshold values to characterize the radio-frequency performance of front-end circuitry 44.

The steps shown in FIG. 8 are merely illustrative. If desired, any performance metric associated with the frequency-domain data signal received by test host 14 from DUT 10 may be used to characterize the performance of front-end circuitry 44. For example, noise floor values such as noise floor 78 of FIG. 5, thermal noise, etc. may be used to characterize the performance of front-end circuitry 44. In this example, if the noise floor and/or thermal noise is sufficiently high, front-end circuitry 44 may have unacceptable performance. If the noise floor is sufficiently low, front-end circuitry 44 may have acceptable performance.

The foregoing is merely illustrative of the principles of this invention and various modifications can be made by those skilled in the art without departing from the scope and spirit of the invention. The foregoing embodiments may be implemented individually or in any combination.

What is claimed is:

1. A method of testing a device under test, comprising:
generating test data using digital demodulator circuitry in the device under test, wherein the test data reflects whether the device under test satisfies wireless performance criteria.

2. The method defined in claim 1, further comprising:
receiving radio-frequency test signals with the device under test, wherein the test data is generated in response to receiving the radio-frequency test signals.

3. The method defined in claim 2, further comprising:
with the digital demodulator circuitry, demodulating the received radio-frequency test signals using a digital modulation scheme selected from the group consisting of: binary phase-shift keying (BPSK), Gaussian minimum shift-keying (GMSK), 8 phase shift keying (8PSK), and 16 phase quadrature amplitude modulation.

4. The method defined in claim 2, wherein using the digital demodulator circuitry to generate the test data comprises generating the test data without using a wireless communications protocol.

5. The method defined in claim 2, wherein the digital demodulator circuitry comprises transformation circuitry, the method further comprising:
with the transformation circuitry, converting the received radio-frequency test signals from time-domain to frequency-domain to generate the test data.

6. The method defined in claim 5, wherein the transformation circuitry comprises fast Fourier transform circuitry, the method further comprising:
with the fast Fourier transform circuitry, performing at least one discrete Fourier transform on the received radio-frequency test signals to generate the test data.

7. The method defined in claim 5, wherein the received radio-frequency test signals comprise in-phase and quadrature-phase (I/Q) components, and wherein converting the received radio-frequency test signals comprises converting the I/Q components from the time-domain to the frequency-domain to generate the test data.

8. The method defined in claim 5 wherein converting the received radio-frequency test signals from the time-domain to the frequency-domain to generate the test data comprises generating noise floor data for the received radio-frequency test signals.

9. The method defined in claim 5, wherein converting the received radio-frequency test signals from the time-domain to the frequency-domain to generate the test data comprises generating signal-to-noise ratio data for the received radio-frequency test signals.

10. The method defined in claim 2, further comprising:
in response to receiving the radio-frequency test signals, generating additional test data based on a communications protocol using radio-frequency decoding circuitry in the device under test, wherein the additional test data comprises error rate data, and wherein the additional test data reflects whether the device under test satisfies wireless performance criteria.

11. The method defined in claim 10, further comprising:
with the radio-frequency decoding circuitry, decoding the received test signals to obtain the additional test data using a wireless communications protocol selected from the group consisting of: the Global System for Mobile Communications (GSM) protocol, the Code Division Multiple Access (CDMA) protocol, the Wideband Code Division Multiple Access (WCDMA) protocol, the “3G” Universal Mobile Telecommunications System (UMTS) protocol, and the “4G” Long Term Evolution (LTE) protocol.

12. A method for testing a device under test having a circuit, comprising:
receiving radio-frequency test signals with the device under test; and
using the circuit, performing Fourier transform operations on the received radio-frequency test signals to obtain corresponding radio-frequency data that is indicative of whether the device under test satisfies wireless performance criteria.

13. The method defined in claim 12, wherein performing the Fourier transform operations on the received radio-frequency test signals comprises performing fast Fourier transform operations on the received radio-frequency test signals to obtain the corresponding radio-frequency data.

14. The method defined in claim 12, wherein the radio-frequency data comprises noise floor data, and wherein performing the Fourier transform operations on the received radio-frequency test signals to obtain the corresponding radio-frequency data comprises performing the Fourier transform operations on the received radio-frequency test signals to obtain the noise floor data.

15. The method defined in claim 14, further comprising:
with the circuit, generating signal-to-noise ratio data associated with the received radio-frequency test signals using the noise floor data.

16. The method defined in claim 12, wherein the received radio-frequency test signals comprise communications protocol encoded radio-frequency test signals, wherein performing the Fourier transform operations comprises performing the Fourier transform operations on the received communications protocol encoded radio-frequency test signals without decoding the communications protocol encoded radio-frequency test signals.

17. The method defined in claim 12, wherein the device under test comprises radio-frequency amplifier circuitry that amplifies the received radio-frequency test signals, the method further comprising:
with the radio-frequency amplifier circuitry, conveying the received radio-frequency test signals to the circuit, wherein the obtained corresponding radio-frequency data is indicative of whether the radio-frequency amplifier circuitry satisfies wireless performance criteria.

18. A method for using a test system to characterize a device under test, wherein the test system includes a test host, the method comprising:
with digital demodulator circuitry in the device under test, generating data signals and performance data associated with the data signals;
with radio-frequency decoding circuitry in the device under test, receiving the data signals from the digital demodulator circuitry; and
with the test host, gathering the performance data from the device under test and performing pass-fail testing on the device under test based on the performance data.

19. The method defined in claim 18, further comprising:
with the digital demodulator circuitry, using a digital modulation scheme selected from one of: binary phase-shift keying (BPSK), Gaussian minimum shift-keying (GMSK), 8 phase shift keying (8PSK), or 16 phase quadrature amplitude modulation to generate the data signals.

20. The method defined in claim 18, further comprising:
with the radio-frequency decoding circuitry, decoding the data signals using a radio access technology selected from the group consisting of: the Global System for Mobile Communications (GSM) protocol, the Code Division Multiple Access (CDMA) protocol, the Wideband Code Division Multiple Access (WCDMA) protocol, the “3G” Universal Mobile Telecommunications System (UMTS) protocol, and the “4G” Long Term Evolution (LTE) protocol.

21. The method defined in claim 18, wherein the digital demodulator circuitry comprises transformation circuitry, the method further comprising:
with the transformation circuitry, generating the performance data associated with the data signals by performing at least one discrete Fourier transform on the generated data signals.

22. The method defined in claim 21, wherein generating the performance data comprises computing a noise floor associated with the gathered performance data, and wherein performing the pass-fail testing comprises comparing the computed noise floor to a predetermined threshold using the test host.

23. The method defined in claim 21, wherein generating the performance data comprises computing a signal-to-noise ratio associated with the gathered performance data, and wherein performing the pass-fail testing comprises comparing the computed signal-to-noise ratio to a predetermined threshold using the test host.

24. The method defined in claim 21, wherein performing pass-fail testing on the device under test based on the performance data comprises:
with the test host, computing a signal-to-noise ratio associated with the gathered performance data; and
with the test host, comparing the computed signal-to-noise ratio to a predetermined threshold.
